(19) United States
(12) Patent Application Publication
(10) Pub. No.: US 2025/0010665 A1
(43) Pub. Date: Jan. 9, 2025

(54) TIRE WITH HIGH COMPRESSION SET ELASTOMER HAVING IMPROVED WEAR PERFORMANCE WITHOUT SACRIFICING HYDROPLANING PERFORMANCE OR SNOW PERFORMANCE

(71) Applicants: Mark E. COLLETT, Greenville, SC (US); Jason SCHOENMAKER, Greenville, SC (US); Philip KOVANIS, Greenville, SC (US); Jeremy John MEHLEM, Greenville, SC (US); COMPAGNIE GENERALE DES ETABLISSEMENTS MICHELIN, Clermont-Ferrand (FR)

(72) Inventors: Mark E. COLLETT, Simpsonville, SC (US); Jason SCHOENMAKER, Simpsonville, SC (US); Philip KOVANIS, Greer, SC (US); Jeremy John MEHLEM, Greenville, SC (US)

(21) Appl. No.: 18/701,952

(22) PCT Filed: Oct. 18, 2021
(86) PCT No.: PCT/US2021/055410

§ 371 Date: Apr. 17, 2024

(51) Int. Cl. B60C 11/12; B60C 11/00; B60C 11/03

(52) U.S. Cl. CPC B60C 11/1236; B60C 11/0008; B60C 2011/0016; B60C 2011/0344; B60C 2011/0358; B60C 2011/0388; B60C 2011/039

(57) ABSTRACT

A tread design for a tire is described herein that has excellent wear properties, hydroplaning resistance, and snow grip. The combination of features also makes it suitable for use in high torque high load conditions found in modern day light truck applications. The tread (18) includes a plurality of tread features lateral sipes (30), lateral grooves (28), longitudinal sipes (31) and longitudinal grooves (24), the longitudinal grooves arranged to form a plurality of ribs (32), each rib extending annularly around the tread and where adjacent ribs are separated by one of the longitudinal grooves, the plurality of ribs including a pair of shoulder ribs and a plurality of central ribs. At least one of the plurality of central ribs is continuous in the longitudinal direction and the elastomeric material forming the tread possesses high compression set allowing the material to plastically deform creating a more rigid tread structure.

### FIELD

Embodiments of this disclosure relate generally to pneumatic tires.

### BACKGROUND

In the design of pneumatic tires, it is desirous to achieve any of a variety of performance parameters. It is often the case that to achieve certain performance goals, other performance measures are sacrificed. Particularly, modern light trucks develop greater torque to satisfy consumer desire for increased cargo and towing capacity, while consumers continue to expect long tread life and good traction. With such developments, light truck tires are subject to greater wear resulting in decreasing tire wear lifespans. In particular instances, in providing elevated wear performance, a reduction in wet, snow and dry grip has been required. Accordingly, there is a need to provide elevated wear performance without sacrificing wet, snow and dry grip.

### SUMMARY

Embodiments of the disclosure include a pneumatic tire. In particular embodiments, the tire comprises: a pair of annular bead areas spaced apart axially along a rotational axis of the tire; a pair of sidewalls spaced apart axially along the rotational axis of the tire, each sidewall of the pair of sidewalls extending outwardly in a radial direction from one bead area of the pair of bead areas relative to the rotational axis; and, a crown portion arranged widthwise between the pair of sidewalls and extending annularly around the tire. The crown portion including a tread formed of elastomeric material arranged annularly around the crown portion and forming an outer, ground-engaging side upon which the tire is intended to roll upon, the tread having a thickness extending radially and a width extending axially, the tread forming a wearing portion the tire. The crown portion further including one or more belt plies each forming a layer of elastomeric material reinforced with a plurality of elongate reinforcements spaced apart in an array, the one or more belt plies being arranged radially inward and below the tread. The crown portion further including a pair of shoulders, each shoulder forming a portion of the crown arranged adjacent to each sidewall. In at least one embodiment the crown portion further including a cap ply arranged radially outward from the one or more belt plies and between the tread and the one or more belt plies, the cap ply extending at least partially across a full width of at least one of the belt plies and being arranged at least partially within each shoulder. The tread including a plurality of tread features extending a depth within the tread thickness which includes lateral sipes, lateral grooves, and longitudinal grooves, the longitudinal grooves arranged to form a plurality of ribs, each rib extending annularly around the tread and where adjacent ribs are separated by one of the longitudinal grooves, the plurality of ribs including a pair of shoulder ribs and a plurality of central ribs, each of the shoulder ribs arranged along one of opposing widthwise extents of the outer, ground-engaging side and within one of the shoulders and where the plurality of central ribs are arranged between the pair of shoulder ribs. The plurality of tread features extending into the tread thickness substantially to a depth defining a skid depth of the tread, the skid depth being the thickness of the tread intended to be worn during the intended life of the tire tread. The invention includes at least one continuous center ribs having a plurality of lateral sipes. The tread rubber of the invention exhibits a high compression set, thereby allowing the sipes to plastically deform when run under normal loading conditions. This deformation by compression set allows the adjacent wall of each sipe to be closer together making for a narrower sipe. In at least one embodiment there may be at least one bridged longitudinal groove between at least two center ribs. It is appreciated that other variations of the tire may vary by incorporating more or less features as described hereinafter in any combination or by varying the present features as described hereinafter.

The foregoing and other objects, features, and advantages will be apparent from the following more detailed descriptions of particular embodiments, as illustrated in the accompanying drawings wherein like reference numbers represent like parts of particular embodiments.

### DETAILED DESCRIPTION OF THE DRAWINGS

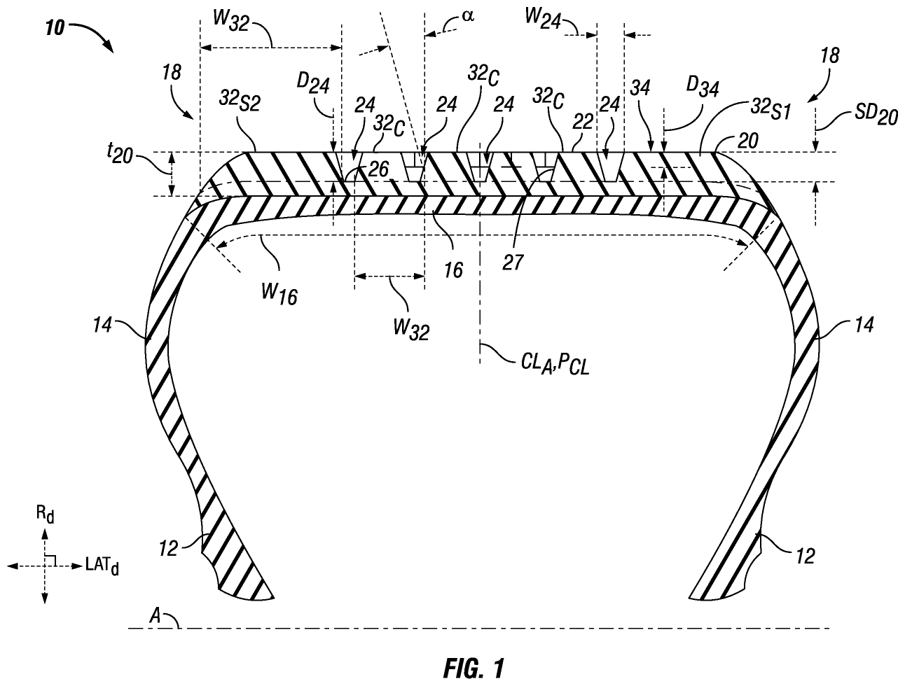

FIG. 1 is a sectional view of a tire taken along a plane extending in both a radial direction and an axial direction, the plane extending through the rotational axis, in accordance with an exemplary embodiment;

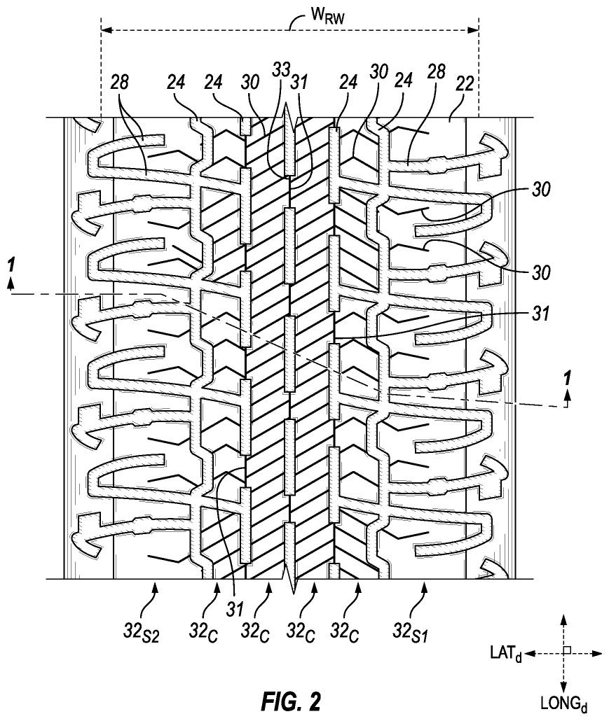

FIG. 2 is a top view of a portion of the tire tread shown in FIG. 1, in accordance with an exemplary embodiment;

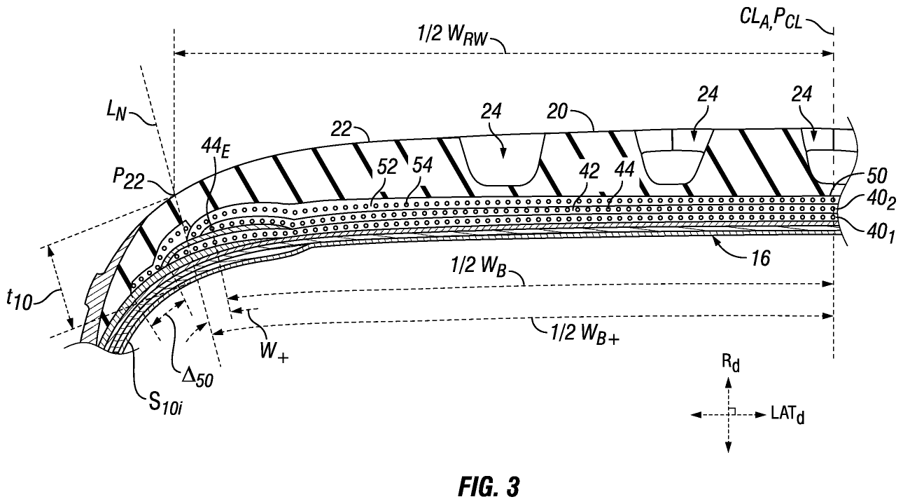

FIG. 3 is a sectional view of the tire shown in FIG. 1, showing how to measure rolling width;

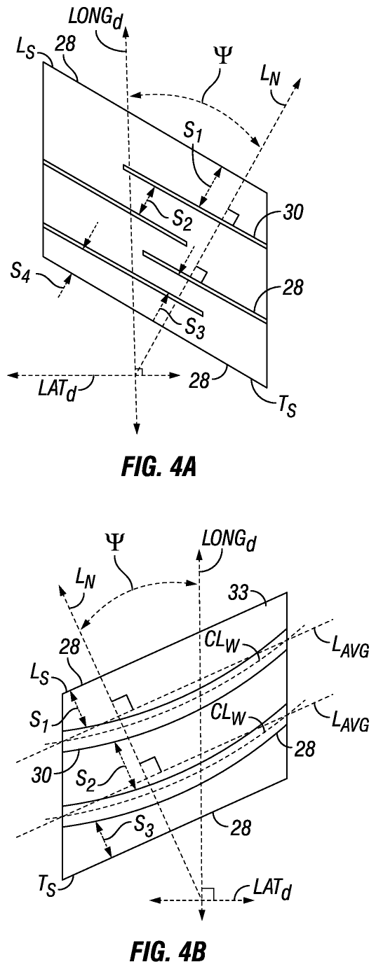

FIG. 4A is a top view of a tread block showing how to measure average inclination angles of lateral grooves and spacings between lateral features;

FIG. 4B is a top view of a tread block also showing how to measure average inclination angles of lateral grooves and spacings between lateral features;

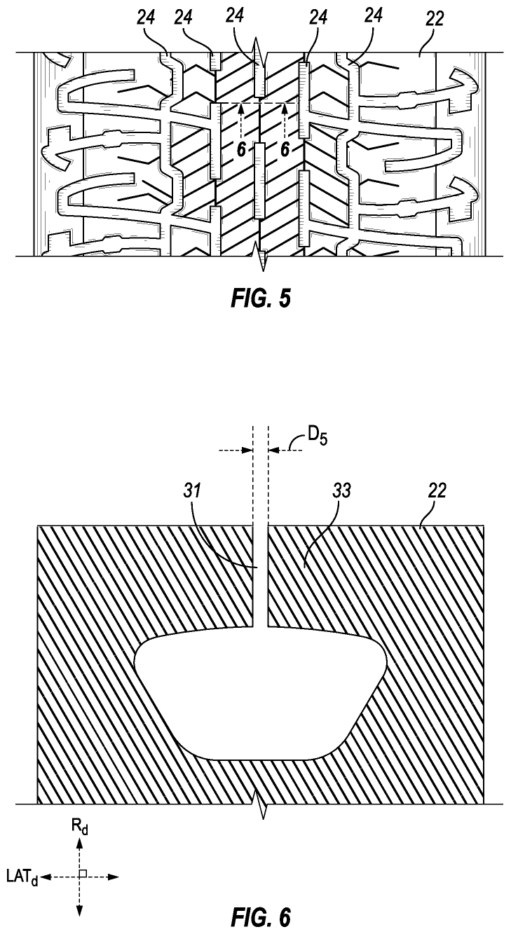

FIG. 5 is a top view of the tread shown in FIG. 2;

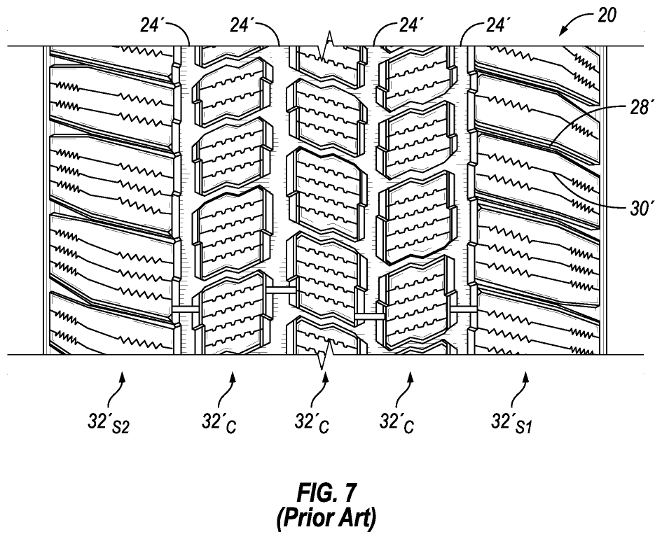

FIG. 6 is a sectional view of a longitudinal sipe of the bridge in FIG. 5;

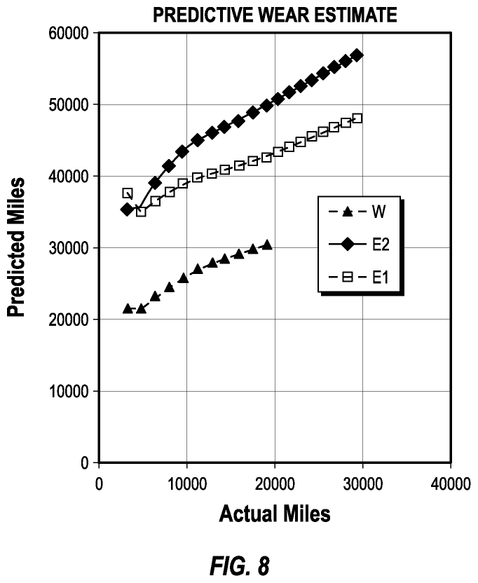

FIG. 7 is a top view of a portion of a prior art tire tread;

FIG. 8 is a chart showing tire performance improvement measures over the prior art.

### DETAILED DESCRIPTION OF PARTICULAR EMBODIMENTS

The present disclosure provides tires characterized as having elevated wet hydro and wear performance that not only fail to sacrifice snow and dry performance but also improve snow and dry performance.

For purposes of describing the invention, reference will now be made to particular exemplary embodiments, one or more examples of which are illustrated in particular figures, or in association with particular figures. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with the features or steps of another embodiment to yield other embodiments or methods. Thus, it is intended that the present invention covers such modifications and variations as come within the scope of the appended claims and their equivalents.

The following terms are defined as follows for this disclosure:

“Axial direction” refers to a direction parallel to the axis of rotation A of the tire or tire carcass, and its components, such as the outer tread, when rolling along a ground surface. “Lateral direction” or “widthwise direction” or the letter LAT_{d} is synonymous with axial direction A.

“Radial direction” or the letter “R_{d}” in the figures refers to a direction that is orthogonal to the axial direction and extends in the same direction as any radius that extends orthogonally from the axial direction. “Radially inward” means in the radial direction R_{d} towards rotational axis A. “Radially inward” means in the radial direction R_{d} away from rotational axis A.

“Circumferential direction,” refers to a direction that is orthogonal to the axial direction and orthogonal to a radial direction. The circumferential direction is the direction of the tire along which it rolls or rotates and that is perpendicular to the axis of rotation of the tire. The circumferential direction is also referred to as a longitudinal direction LONG_{d}.

A “groove” is any elongate void or channel arranged within the tread having a pair of opposing sidewalls extending depthwise into the tread and that which are spaced apart greater than 1.6 mm or, in other variations, by at least 2.0 mm. A groove is designed to have a width, based upon the depth of the groove, to remain open as the tread rolls into, through, and out of a contact patch. A “lateral groove” is a groove that extends in a direction oblique to the longitudinal direction (the circumferential direction). A “longitudinal groove” is a groove that extends substantially in the longitudinal direction. A “circumferential groove” is synonymous with a longitudinal groove, each of which extends annularly around the tire. The grooves may be bridged. A groove may have a bridged portion and still be considered a groove, as long as the walls of the groove radially below the bridge are spaced apart greater than 1.6 mm, or in other variations, at least 2.0 mm. In such instances, the bridged portion of the groove may be split by a sipe.

A “sipe” is any elongate void or incision arranged within the tread having a pair of opposing sidewalls extending depthwise into the tread and that which are spaced apart by less than 2.0 mm or 1.6 mm or less in other variations. Sidewalls of the sipe come into contact from time to time as the tread rolls into and out of the contact patch of the tire as the tire rolls on the ground. By lateral sipe, it is meant a sipe that extends in a direction that is oblique to the longitudinal direction.

A “bridged groove” is a groove where a protrusion forming the bridge extends out from one wall of the groove towards the opposing wall leaving a void at the bottom of the groove under the protrusion, the bridge occurring over a portion of the length of the groove. The bridge may be continuous from one groove wall to the opposing groove wall, or the bridge may be a “split bridge groove” split by a sipe. The sipe may be positioned in the center of the bridge, or closer to one wall or the other.

A “tread element” is portion of the tread defined by one or more grooves and/or sipes arranged along the outer, ground-engaging side of the tread. Examples of tread elements include tread blocks and ribs.

The tire is “loaded” when the tire is subject to normal loading conditions such as found when mounted to a vehicle.

A “rib” is a tread element that runs substantially in the longitudinal direction LONG_{d} of the tire and that is bounded by a pair of longitudinal grooves or by a longitudinal groove and any of the pair of lateral sides defining a width of the tread. A rib may include any lateral features, which includes any lateral grooves and lateral sipes, as well as any arrangement of tread blocks.

A “continuous rib” is a rib having substantially no lateral grooves. By “substantially” the rib has 5 or fewer lateral grooves. In other embodiments a “continuous” rib may have no lateral grooves.

A “tread block” is a tread element having a perimeter that is defined by one or more grooves with or without a lateral side of the tread, thereby creating an isolated structure in the tread. A sipe does not define any portion of a tread block perimeter.

A “contact patch” is the total area contained within a perimeter defining an area of contact, the area of the contact patch including the area of contact contained within the perimeter and any void arranged within the area of contact.

“Elastic material” or “elastomer” as used herein refers to a polymer exhibiting rubber-like elasticity, such as a material comprising rubber, whether natural, synthetic, or a blend of both natural and synthetic rubbers.

“Elastomeric” as used herein refers to a material comprising an elastic material or elastomer, such as a material comprising rubber.

“Modulus of elongation” (MPa) was measured at 10% strain (MA10), at 100% strain (MA100), or at 300% strain (MA300) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

“Resilient” as used herein means configured to bend and flex elastically without plastic or permanent deformation under intended operating conditions.

“Rigid” as used herein means generally unable to elastically or plastically bend or be forced out of shape under intended operating conditions, as opposed to being resilient.

“Dynamic compression set measure include Goodrich, Firestone and Bridgestone Flexometers. Through imposed deformations, applied loads or periodic impacts, these devices apply cyclic compressive energy to the rubber samples for a specific period of time under controlled environmental conditions. Variations in external conditions can included the imposed stresses or strains, ambient temperature, and relative humidity. Industry standard tests include ASTM test 623A and 623B. Compression set was measured on a Goodrich Flexometer according to ASTM D623A and B with the following conditions: permanent set measured after 30 minutes at 80 C, 0.4 Mpa static pressure (10 lbs.), 17.5% cyclical stroke, and 30 Hz (sample geometry: cylinder, 24 mm long, 17 mm diameter).

“Rolling width,” with reference to FIG. 4, refers to a width W_{RW} of the tread 20 that defines a width of the outer, ground-engaging side 22 of the tread 20. This width W_{RW} is defined in accordance with FIG. 4, whereby a distance WB is measured along the radially outermost belt ply 40₂ to the center of the last elongate reinforcement 44 in said ply 40₂ at each widthwise extent of said outermost belt ply 40₂. In this instance, ½ of W_{B} is shown. Upon obtaining this dimension, an additional 3 mm (millimeters) is added to each widthwise extent of W_{B} (6 mm in total) along the same curvilinear path along which W_{B} extends, where the 3 mm addition is represented by W₊. An imaginary line L_{N} extending normal to the curvilinear path along which W_{B+} extends at each widthwise extent of W_{B+} intersects the outer, ground-engaging side 22 at point P₂₂. At each lateral side of the tread, opposing points P₂₂ as measured in the lateral direction LAT_{d} define the rolling width W_{RW} of the tread 20 and outer, ground-engaging side 22, where in FIG. 4 one half (½) of W_{RW} is shown.

“Skid depth” or SD₂₀ is defined as the thickness of the tread extending from the outer, ground-engaging side of the tread to the deepest tread feature (that is, any longitudinal or lateral groove or sipe) extending into the tread. Any thickness of the tread extending radially inward from the skid depth is referred to as the undertread thickness. In particular instances, with reference to FIG. 1, the skid depth SD₂₀ extends along a curvilinear path laterally across the tread and between adjacent longitudinal grooves 24, intersecting each longitudinal groove bottom 26 and extending further along an arcuate path into each shoulder rib 32_{S1}, 32_{S2} at the depth of the deepest lateral groove or sipe, where the skid depth SD₂₀ may or may not be arranged substantially the same distance from the radially outermost cap ply 50 or, if no cap ply is present, the radially outermost belt ply 40 for distance W_{B}. The skid depth SD₂₀ defines the useful thickness of the tread intended to be worn during the life of the tire.

“Contact surface ratio” (CSR) is the surface area of the parts of the tire in contact with the ground to the total area of area inside the perimeter of the contact patch. This is the total area contained within a contact patch (A_{c}) minus the total void area of the grooves and other voids (Aᵥ) as located along the outer, ground-engaging side of the tire tread, which extends annularly around the tire and laterally along the rolling width of the outer, ground-engaging side divided by the total area of the contact patch (A_{c}) that which includes the total void area of the grooves and other voids (Aᵥ). Both areas are measured in mm². This relationship can be expressed in terms of the following equation: CSR=(A_{c}−Aᵥ)/A_{c}, where the equation yields a dimensionless number.

Modulus of elongation (MPa) was measured at 10%, 100%, and 300% (MA10, MA100, MA300) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

With reference to FIG. 1, a pneumatic tire 10 is shown to generally comprise a pair of annular bead areas 12 spaced apart axially along a rotational axis A of the tire 10, a pair of sidewalls 14 spaced apart axially along the rotational axis A of the tire 10, and a crown portion 16 arranged widthwise between the pair of sidewalls 14 and extending annularly around the tire 10. Each sidewall 14 extends outwardly in a radial direction R_{d} from one bead area 12 of the pair of bead areas 12 relative to the rotational axis A. In extending widthwise between the pair of sidewalls 14, it is a width W₁₆ of the crown portion 16 extending between the sidewalls. Rolling width W_{RW} of the tread 20 and outer, ground-engaging side 22 is also shown. Shoulder area is generally designated as 18, and includes shoulder ribs 32_{S1}, 32_{S2}.

With continued reference to FIG. 1, the crown portion 16 includes a tread 20 arranged annularly around the crown portion 16 and forming an outer, ground-engaging side 22 upon which the tire 10 is intended to roll upon. The tread 20 has a thickness t₂₀ extending in a direction perpendicular to the outer, ground-engaging side 22 and in a direction toward the rotational axis A of the tire. The tread thickness t₂₀ extends from the outer, ground-engaging side 22 to a skid depth SD₂₀ of the tread to define a thickness of the tread intended to be worn during the lifetime of the tire (that is, a wearing depth or thickness of the tire tread). The skid depth SD₂₀ is commonly, but not necessarily, arranged at a depth corresponding to the bottom 26 of the deepest longitudinal groove 24. While not necessary, it is commonly the case, such as is shown, where the bottom 26 of all circumferential (longitudinal) grooves 24 is arranged at the skid depth SD₂₀. In such instances, while each circumferential (longitudinal) groove depth D₂₄ may or may not be of the same depth D₂₄, in the exemplary embodiment shown, all circumferential grooves 24 are of equal depth D₂₄ and extend to and terminate at the skid depth SD₂₀. In certain instances, the average depth D₂₄ for all circumferential grooves 24 is 11 mm. This average is calculated over the full circumference of the tire 10. In particular instances, the skid depth SD₂₀ is measured at a widthwise (axial) centerline CL_{A} of the tread 10, the centerline CL_{A} extending along an equatorial plane P_{CL}, where at this location the skid depth SD₂₀ is 11 mm, but may remain the same or vary across the width of the tread. For example, in the FIG. 1 the skid depth SD₂₀ remains generally constant until reaching each shoulder 18, while in FIG. 4 the skid depth SD₂₀ gradually decreases as the tread extends laterally along its width. It is noted that the tread thickness t₂₀ may extend radially inward deeper to a depth beyond the skid depth SD₂₀, such as is generally shown.

In any embodiment contemplated herein, the tread 20 is formed of an elastomeric material, such as any natural or synthetic rubber, or any blend thereof. In particular instances, the tread is substantially formed of an elastomeric material to provide a high compression set material which is characterized as having a compression set greater than 4% as measured under the conditions described herein. An elastomeric material so characterized may be formed using any of a variety of formulations. An elastomeric material so characterized may be formed using any of a variety of formulations. In particular instances, the so characterized elastomeric material is a mixture including an elastomer, a filler, and a plasticizer. In this formulation, the elastomer ranges from an SBR/BR blend containing at least 55% BR to 100% BR, or in other variations a 70/30 or 85/15 blend of BR and SBR, respectively. “SBR” means styrene-butadiene rubber while “BR” means butadiene rubber. The filler in this formation comprises silica and carbon black, silica forming 30 wt % to 35.9 wt % and the carbon black forming 0-5 wt % of the total elastomeric material mixture. The High Tg Resin plasticizer in this formation forms 10 wt % to 16 wt % of the total elastomeric material mixture. The vulcanization system of this material is composed of less than 0.8 phr sulfur and less than 3.1 phr of accelerators. The activator system is composed of 1 phr of Stearic acid and 1.9 phr of ZnO. It is appreciated that other formations may be employed to achieve the desired characteristics and properties.

The elastomers useful for forming the elastomeric material compositions disclosed herein, such as for the tread 20, may have any microstructure, such microstructure being a function of the polymerization conditions used, in particular of the presence or absence of a modifying and/or randomizing agent and the quantities of modifying and/or randomizing agent used. The elastomers may, for example, be block, random, sequential or micro-sequential elastomers, and may be prepared in dispersion or in solution; they may be coupled and/or starred or alternatively functionalized with a coupling and/or starring or functionalizing agent.

Functionalized rubbers, i.e., those appended with active moieties, are well known in the industry. The backbone or the branch ends of the elastomers may be functionalized by attaching these active moieties to the ends of the chains or to the backbone or mid-chains of the polymer. Exemplary functionalizing agents that could be included with the diene elastomers include, but are not limited to, metal halides, metalloid halides, alkoxysilanes, imine-containing compounds, esters, ester-carboxylate metal complexes, alkyl ester carboxylate metal complexes, aldehydes or ketones, amides, isocyanates, isothiocyanates and imines-all of these being well-known in the art. Particular embodiments may include non-functionalized diene elastomers while other embodiments may be limited to including functionalized elastomers.

Particular embodiments of the rubber compositions disclosed herein are limited to those having at least 80 phr of the rubber components being highly unsaturated diene elastomers. Other embodiments are limited to having at least 90 phr or 100 phr of the highly unsaturated diene elastomer components.

Examples of suitable highly unsaturated diene elastomers include, but are not necessarily limited to natural rubber (NR) and synthetic rubbers such as polybutadienes (BR), polyisoprenes (IR), butadiene copolymers, isoprene copolymers and mixtures of these elastomers. Such copolymers include butadiene/styrene copolymers (SBR), isoprene/butadiene copolymers (BIR), isoprene/styrene copolymers (SIR) and isoprene/butadiene/styrene terpolymers (SBIR). Any of these examples or mixtures of these examples are suitable for particular embodiments of the rubber compositions disclosed herein.

In particular embodiments, useful SBR elastomers may have a bound styrene content of between 1 mol % and 45 mol % or alternatively between 15 mol % and 40 mol % or between 20 mol % and 30 mol %.

With reference to FIG. 3, the crown portion 16 further includes one or more belt plies 40 (generally, while more specifically showing first and second belt plies 40₁, 40₂) each forming a layer of elastomeric material 42 reinforced with a plurality of elongate reinforcements 44 spaced apart in an array, the one or more belt plies being arranged radially inward and below the tread. Together, the one or more belt plies form a “belt,” the belt also being referred to as a “belt structure” and forming an annular structure formed by all of the one or more belt plies 40). Each elongate reinforcement 44 may be formed of metal or non-metal elongate reinforcements, where the elongate reinforcements 44 are formed of a plurality of filaments arranged lengthwise and twisted along their lengths as desired. Metal elongate reinforcements are constructed from filaments most commonly formed of steel, but may be formed any metal having desirous properties. Non-metal reinforcements are constructed from filaments formed of any fabric or textile, such as polyester, rayon, nylon, aramid, silk, and/or fiberglass. In the exemplary embodiment shown, the tire 10 includes a pair of belt plies 40 to form an annular belt structure, although any single belt ply 40 or three or more belt plies 40 may be employed to achieve the desired properties of the annular belt structure formed by any one or more belt plies 40.

With continued reference to FIG. 3, the crown portion 16 of the embodiment shown further includes a cap ply 50 arranged radially outward from the one or more belt plies 40 and from the annular belt structure formed by all belt plies contained within the tire. The cap ply 50 is arranged between the tread 20 and the one or more belt plies 40 (that is, belt). The cap ply 50 extends at least partially or substantially across a full width of at least one of the belt plies 40 or more generally at least partially or substantially across a full width of the belt. In doing so, the cap ply 50 is at least partially arranged within each shoulder 18 or shoulder rib 32_{S1}, 32_{S2}.

The cap In particular instances, each of the first and second shoulder ribs have a width ply 50 is formed of a layer of elastomeric material 52 reinforced with a plurality of elongate reinforcements 54 spaced apart in an array. The elongate reinforcements 54 are arranged to extend lengthwise substantially in a circumferential direction C_{d} of the tire, that is, in a direction substantially parallel to a plane P_{CL} bisecting the tire at its equatorial centerline CL_{A} and extending perpendicular to rotational axis A. “Substantially parallel” means that any such elongate reinforcement 54 extends by an angle or 0 to 5 degrees in absolute value (that is, spanning −5 degrees to 5 degrees) relative to the longitudinal direction LONG_{d} or plane P_{CL}.

Cap ply 50 may be applied in any desired manner. For example, in certain exemplary instances, cap ply 50 is formed using one or more sheets wound once around the tire, the sheets including the elastomeric material 52 and elongate reinforcements 54, while in other exemplary instances the cap ply 50 is formed using one or more strips wound multiple revolutions around the tire in a helical configuration, the strips including the elastomeric material 52 and elongate reinforcements 54. In winding into a helical configuration, each wind of the strip is arranged to abut the adjacent wind of strip, or, in other variations, may be spaced apart from or overlap an adjacent wind by as much as a 50% (providing a spacing or overlap, where, for example, a 50% overlap forms ½ pace between winds of the strip). It is appreciated that one or more cap plies 50 may be employed. At each widthwise end of the belt, before beginning the helical wind at one end and after reaching the other end after making the plurality of helical winds, a full revolution of the cap strip is made. In doing so, the cap ply extends 4 mm to 14 mm beyond the belt, that is, beyond the widest of the one or more belt plies 40 at each widthwise extent of the belt.

Each elongate reinforcement 54 may be formed of metal or non-metal elongate reinforcements, where elongate reinforcements are formed of a plurality of filaments arranged lengthwise and twisted along their lengths as desired. Metal elongate reinforcements are constructed from filaments most commonly formed of steel, but may be formed any metal having desirous properties. Non-metal reinforcements are constructed from filaments formed of any fabric or textile, such as polyester, rayon, nylon, aramid, silk, and/or fiberglass.

For any belt or cap ply formed of elastomeric material having elongate reinforcements, the array of elongate reinforcements may be coated with the elastomeric material or skim (layers) of elastomeric may be applied to opposing sides of the array. It is appreciated, however, that any other manner may be employed for providing any such ply.

With reference to FIGS. 1 and 2, the tire tread 20 includes a plurality of features extending a depth within the tread thickness that include longitudinal (circumferential) grooves 24, lateral sipes 31, lateral grooves 28, and lateral sipes 30. These features are arranged along the outer, ground-engaging side 22, although any such feature may be submerged below the outer, ground-engaging side 22 to be later exposed after a particular depth of the tread 20 has been worn away. In the embodiment shown, the longitudinal grooves 24 are arranged to form a plurality of ribs 32, each rib extending annularly around the tread such that adjacent ribs are separated by one of the longitudinal grooves 24. The plurality of ribs include a first shoulder rib 32_{S1}, a second shoulder rib 32_{S2}, and a plurality of central ribs 32_{C}. Each of the first and second shoulder ribs 32_{S1}, 32_{S2} are arranged along one of opposing widthwise extents of the outer, ground-engaging side 22, where the plurality of central ribs 32_{C} are arranged axially (laterally) between the first and second shoulder ribs 32_{S1}, 32_{S2}. Generally, in combination with the different embodiments contemplated herein, each of the ribs 32_{S1}, 32_{S2}, 32_{C} may be characterized as having any desired width, where the rib widths W₃₂ may be the same or different between the ribs 32_{S1}, 32_{S2}, 32_{C}. In particular instances, each of the first and second shoulder ribs have a width W₃₂ equal to 19% to 35% of the tread width. Further, in certain instances, the width W₃₂ of each first and second shoulder rib 32_{S1}, 32_{S2} has a width W₃₂ equal to 186% to 335% of an average width of the central ribs 32_{C}. While the average width W₃₂ of each central rib 32_{C} may be different than any one or more of the other central ribs 32_{C}, in particular instances the average width W₃₂ of each central rib is substantially the same. It is appreciated that while any number of ribs may be employed, in certain embodiments the tread has 6 ribs (shown) or 5 ribs (not shown). In the embodiment shown, the tire tread features form an symmetrical (albeit, not “mirrored”), non-directional tire tread pattern design, where non-directional means that the tire may be mounted in to rotate in either of opposing circumferential directions. It is appreciated, however, that a directional tread pattern design may also be employed and likewise it may have a symmetrical tread pattern mirrored across the center line (CL_{A}) or an asymmetrical tread pattern.

In other embodiments the first and second shoulder ribs have a width W₃₂ equal to 19% to 25% of the tread width. Further, in these instances, the width W₃₂ of each first and second shoulder rib 32_{S1}, 32_{S2} has a width W₃₂ equal to 240% to 310% of an average width of the central ribs 32_{C}.

With reference to FIGS. 1 and 2, it is also noted that longitudinal grooves 24 each have a width W₂₄ defined by a pair of opposing groove sidewalls 27. It is appreciated that each of the longitudinal grooves 24 may have the same of different widths W₂₄, and in particular embodiments the longitudinal groove widths W₂₄ are selected to provide the contact surface ratios discussed elsewhere herein. While each groove sidewall 27 may extend into the tread thickness t₂₀ at any angle a relative to a direction perpendicular to the outer, ground-engaging side 22, in particular exemplary instances each groove sidewall 27 extends at an angle α measuring 0° to 12° relative to a direction perpendicular to the outer, ground-engaging side 22. As noted previously, each longitudinal groove 24 has a depth D₂₄ extending into the tread thickness to a bottom 26, where all of the longitudinal grooves may be of the same or different depth D₂₄. Longitudinal sipe 31 may be present in the tread extending into the tread thickness t₂₀ at any angle relative to the direction perpendicular to the outer ground engaging side 22. In the embodiment shown, the sipes extend at an angle perpendicular to the ground engaging side 22.

In at least one embodiment of the present invention, a plurality of longitudinal sipes 31 occur between at least two adjacent central longitudinal ribs as shown in FIG. 6, which is a cross section taken along line 6-6 of FIG. 5. The sipes occur within a bridge 33 over a longitudinal groove 24 that extends from one central rib 32C to an adjacent central rib 32C. Each longitudinal sipe 31 is shown to be positioned midway between the adjacent ribs 24 and extend perpendicular to the ground engaging side 22 in the present embodiment. A plurality of bridges 33 are intermittently placed longitudinally around the tire within the at least one longitudinal groove 24 thereby having bridged groove portions of the longitudinal groove separated by non-bridged groove portion of the longitudinal groove. The void beneath the bridge 33 allows water to egress from the groove as the tire rolls. The bridge provides additional surface area to make contact with the road surface and the narrow sipe 31 allows for additional stability when the tire is compressed in the contact patch and the two sides of he bridge 33 make contact with one another. In the embodiment shown, three central groves 24 between the four central ribs 32_{C} each possess a plurality of bridges 33 having longitudinal sipes 31.

With continued reference to FIG. 2, it is noted as well that tread 20 includes lateral grooves 28 and lateral sipes 30, all of which together are referred to as lateral features. It is noted that should any adjacent lateral features be arranged within 1 mm of one another, the adjacent features are considered a single feature. Notably, in the present embodiment, at least one of the central ribs 32_{C} are continuous ribs, that is, they lack any lateral grooves 28. The shoulder ribs 32_{S1}, 32_{S2} possess a plurality of lateral grooves. This creates a higher CSR of the central portion of the tread compared to the shoulder region of the tread, and in particular increases the CSR of the central ribs 32_{C} when compared to the shoulder ribs as well as increases the longitudinal rigidity of the central ribs 32_{C} compared to the shoulder ribs 32_{S1}, 32_{S2}.

With general reference to FIG. 2, it is appreciated that each lateral feature (lateral grooves 28 and lateral sipes 30) may include a chamfer arranged at the intersection of a lateral feature 28, 30 (a sidewall thereof) with the outer, ground-engaging side 22.

In any embodiment contemplated herein, the lateral grooves may have an inclination angle. With reference to FIGS. 4A and 4B, these angles ψ may be measured relative to the longitudinal direction LONG_{d}, where angle ψ is measured between the longitudinal direction LONG_{d} and a line L_{N} extending normal to the groove length L₂₈. In FIG. 4A, each lateral groove 28 extends linearly. In FIG. 4B, where each lateral groove extends lengthwise along a curvilinear path, the average angle may be measured differently. For example, in the figure shown, the average angle ψ is obtained by extending an imaginary line L_{avg} from the terminal ends of the lateral groove length L₂₈ at a widthwise centerline CL_{W} of the lateral groove 28, where the terminal ends here are arranged at each lateral side of the tread block although in other variations a lateral groove may terminate inward of any side edge of the tread block. In other instances, an imaginary line L_{avg} may be determined using linear regression taking into account the lengthwise path of the longitudinal groove widthwise centerline CL_{W}. Once the imaginary line L_{avg} is determined, angle ψ is measured relative to a line L_{N} extending normal therefrom. In other variations, angle ψ may be measured relative to the lateral direction LAT_{d} from a linear longitudinal groove length L₂₈ or from the imaginary line L_{avg}.

In any embodiment contemplated herein, an average spacing (density) is contemplated for all lateral features, that is, all lateral grooves 28 and all lateral sipes 30. Specifically, with reference to FIGS. 4A and 4B, a spacing S (S₁, S₂, S₃, S₄) is provided between adjacent lateral features 28, 30, whether adjacent lateral features form a pair of lateral grooves 28, a pair of lateral sipes 30, or a lateral groove 28 and a lateral sipe 30. It is noted that LS identifies a leading side of the tread block shown as formed by a lateral groove, while TS identifies a trailing side of the tread block as formed by a lateral groove. While the spacings S are shown to be constant, spacings S may be variable in other instances. It is appreciated that the average angle may be the same or vary amongst the various ribs 32_{S1}, 32_{S2}, and 32_{C}.

With reference to FIGS. 4A and 4B, these spacings S are measured relative to the longitudinal direction Long_{d}, where spacing S is measured in the direction of a line L_{N} extending normal to the lateral feature length L₂₈, L₃₀. In FIG. 4A, each lateral feature 28, 30 extends linearly. In FIG. 4B, where each lateral groove extends lengthwise along a curvilinear path, the spacing S (S₁, S₂, S₃) is measured in a direction defined by a line _{N} extending normal to an imaginary line L_{avg} extending through the terminal ends of the lateral groove length L₂₈ at a widthwise centerline CL_{W} of the lateral groove 28, where the terminal ends here are arranged at each lateral side of the tread block although in other variations a lateral groove may terminate inward of any side edge of the tread block. In other instances, an imaginary line L_{avg} may be determined using linear regression taking into account the lengthwise path of the longitudinal groove widthwise centerline CL_{W}. Once the imaginary line L_{avg} is determined, the spacings S (S₁, S₂, S₃) are measured in the direction of line L_{N} extending normal to line L_{avg}.

It is appreciated that each of the tread features, that is, each of the longitudinal grooves 24, lateral grooves 28, lateral sipes 30, and compliance features 34 (partial depth grooves or sipes extending substantially in the longitudinal direction LONG_{d}) form edges located at the intersection of the depth wise extension of each such tread feature and the outer, ground-engaging side 22. In other words, an edge is formed where any sidewall of any lateral sipe or of any lateral groove intersects the outer, ground-engaging side. As noted previously, some of these tread features may include one or more chamfers 60, and so the edges may be arranged at the intersection of the chamfer with the outer, ground-engaging side 22. In any event, as described above in conjunction with FIG. 6, a longitudinal lateral sipe edge density may be determined for the lateral sipes 30, while a longitudinal non-lateral sipe edge density may be determined collectively for the other tread features, namely, for all longitudinal grooves 24, lateral grooves 28, and the elongate compliance features 34 (that is, all partial depth grooves or sipes extending in the longitudinal direction), in combination.

As defined above, longitudinal contact surface ratio (longitudinal CSR) associates the total area of the outer, ground-engaging side minus all void present along the outer, ground-engaging side provided by all circumferential grooves with the total area arranged along the outer, ground-engaging side 22 in the form of a ratio. The total area of the outer, ground-engaging side 22 includes both the surface area of the tread and all void arranged along the outer, ground-engaging side, represented as surface area void along the outer, ground-engaging side.

FIG. 7 shows a typical prior art comparative light truck tire tread 20′, having five ribs 32′ of tread blocks, with each rib having individual blocks separated by lateral groove 28′ and each block possessing a plurality of lateral sipe features 30′. The conventional wisdom of tire design of a tire having good wear was to provide a tire with each of the ribs having a similar contact surface ratio. In order to provide adequate wet hydroplane performance, large open longitudinal grooves and ample lateral grooves provided space for water egress as the tread rolls through the contact patch. Interfering with this egress, by providing longitudinal bridging or other features within these longitudinal blocks, would have been thought to impede water egress and increase the potential for tire hydroplaning (where the tire would decrease or lose its contact with the ground surface, and therefore loose traction).

The novel light truck tire presented surprisingly possesses remarkably reduced wear compared to such prior art sculpture designs, while maintaining or even improving upon wet hydroplane traction, snow and dry traction performance. Such performance improvement is not anticipated by the design of a tire that occludes longitudinal groove water evacuation and limit lateral grooves in one or more central ribs. The tire's solid central rib provides a ridged rubber interface with the ground surface. Since it is understood that tire wear occurs as the tread block slips as it enters and exits the contact patch, providing a central rib lacking lateral grooves provided the expected improvement of reduced tire wear. The solid central rib, or ribs in the case of the present embodiment, help further reduce deformation of the tread rubber under the heavy loading and heavy torque of light truck tire loading. This reduces the rubber shear strain at the trialing edge of the contact patch while providing the necessary longitudinal and or transversal forces required for vehicle motion. The increased rib rigidity reduces the slip between the tire tread surface 20 and the ground surface as the rubber exits tire contact patch. These two effects reduce the tire tread wear as shown in FIG. 8 even under the demanding power and torque performances of modern light truck tires.

FIG. 8 shows a graph of predictive tire wear based on testing of the tires under real life conditions. The data is obtained by subjecting test tires to wear on actual on-road travel over an abbreviated duration as specified in the horizontal axis and measuring tread wear periodically during the testing. Based on the rate of tread wear, as measured by the tread depth, the predictive milage, shown on the vertical axis, is calculated at which point the model predicts the tread will have reached at least 2/32 tread depth, representing the tread life of the tire. As can be seen in the figure, the witness tire (W) represents a light truck tire having a tread sculpture represented by FIG. 7. The inventive tread sculpture is represented by E1 of the figure. A significant increase in tread wear performance is observed, with the predictive model having a similar upward slope, representing a similar reduced tread wear rate as the tire wears. The inventive tread sculpture having a tread compound having increased compression set is represented by E2 in the graph. The unexpected improvement is shown by the marked increase of slope of the wear graph line of E2. This represents that the wear rate is similar to E1 initially, as would be expected, but improves dramatically as the tire tread experiences compression set. The rubber, over time, plastically deforms under dynamic conditions and due to the poison effect, the sipes' gaps in the tread close. This phenomenon causes the tread blocks to lock up and have an overall increase in effective tread stiffness, synergistically improving tread wear.

The wet braking performance of a tire mounted on an automobile fitted with an ABS braking system is measured by determining the distance necessary to go from 40 mph to a complete stop upon sudden braking on a wetted (no puddles) asphalt surface. A value greater than that of the control, which is arbitrarily set to 100, indicates an improved result, i.e., a shorter braking distance indicating improved wet grip.

A 5% improvement in stopping distance was observed in proprietary wet braking testing as described above using a light truck. Generally, a higher contact surface area would be expected to decrease wet braking performance. The applicant hypothesize that the increase hydro performance is due to the higher contact surface ratio in the center of the tire, and, relative to the center, a lower contact surface ratio in the shoulders, combined with lateral groove feature in the shoulders which it is hypothesized has a similar effect to that of “rounding” the contact patch. As such, the water is pushed by the tire from the centerline of the tire at the beginning of the contact patch to the outside shoulder areas where the water is evacuated by the lateral and longitudinal features. The intermittent bridges allow for limited but adequate water evacuation in the central portion of the tire toward the middle of the contact patch. This hydro-performance, however, was not anticipated, and the applicant's initial expectation was a decrease of hydro-performance due to the increased contact surface ratio and longitudinal grooves interrupted by lateral bridging.

Snow performance was evaluated by a “GM spin test” and a subjective snow handling test. GM spin testing was performed to evaluate the inventive tread sculpture compared to the prior art witness sculpture. The grip on snow-covered ground is evaluated by measuring the forces on a single driven axle test in snow according to the ASTM F1805 test method. The vehicle travels at a constant 5 mph speed and the forces are measured on the single test tire at the target slip. A value greater than that of the Standard Reference Test Tire (SRTT), which is arbitrarily set to 100, indicates an improved result, i.e., improved grip on snow. Subjective snow testing was performed by a Lateral acceleration under snow conditions is measured objectively using accelerometers during vehicle testing along a testing course. During such testing, at least 5 laps along a road course were conducted by different drivers, where subjective snow handling measures were provided by the drivers according to SAE standards while accelerometers were used to measure acceleration, deceleration, and lateral accelerations along predefined segments along the testing course. The data was filtered and averaged to provide accurate results.

Both the GM spin test and the subjective snow handling test showed an unexpected similar performance to that of the prior art tread sculpture. With reduced lateral voids, a tire designer would expect the ability for the tire to “bite” into the snow to be reduced. This reduced lateral void would mean less traction on snow for subjective handling and it would be expected to reduce the performance of the GM spin test. What was found during testing, however, was different than what was expected. In GM Spin testing, there was not a significant difference between the tire with the inventive sculpture and the prior art witness. During subjective snow handling, the inventive tire was credited with a 0.5-point advantage over the witness tire. In particular the bridged center section is believed to provide areas for snow packing despite the reduced lateral grooves and the bridged portions provide an additional lateral edge for additional snow traction.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

What is claimed is:

1. A light truck pneumatic tire comprising:
a pair of annular bead areas spaced apart axially along a rotational axis of the tire;
a pair of sidewalls spaced apart axially along the rotational axis of the tire, each sidewall of the pair of sidewalls extending outwardly in a radial direction from one bead area of the pair of bead areas relative to the rotational axis;
a crown portion arranged widthwise between the pair of sidewalls and extending annularly around the tire;
the crown portion including a tread formed of elastomeric material arranged annularly around the crown portion and forming an outer, ground-engaging side upon which the tire is intended to roll upon, the tread having a thickness extending radially and a width extending axially, the tread forming a wearing portion the tire;
the crown portion further including one or more belt plies each forming a layer of elastomeric material reinforced with a plurality of elongate reinforcements spaced apart in an array, the one or more belt plies being arranged radially inward and below the tread;
the crown portion further including a pair of shoulders, each shoulder forming a portion of the crown arranged adjacent to each sidewall;
the tread including a plurality of tread features extending a depth within the tread thickness which includes lateral sipes, lateral grooves, and longitudinal grooves, the longitudinal grooves arranged to form a plurality of ribs, each rib extending annularly around the tread and where adjacent ribs are separated by one of the longitudinal grooves, the plurality of ribs including a pair of shoulder ribs and a plurality of central ribs, each of the shoulder ribs arranged along one of opposing widthwise extents of the outer, ground-engaging side and within one of the shoulders and where the plurality of central ribs are arranged between the pair of shoulder ribs;
the plurality of tread features extending into the tread thickness substantially to a depth defining a skid depth of the tread, the skid depth being the thickness of the tread intended to be worn during the intended life of the tire tread;
wherein at least one of the plurality of central ribs is continuous in the longitudinal direction;
wherein the elastomeric material forming the crown possesses a compression set of greater than 4%.

2. The tire of claim 1 wherein at least two of the plurality of central ribs are continuous in the longitudinal direction.

3. The tire of claim 2 wherein the at least two of the plurality of central ribs are separated from each other by a bridged longitudinal groove.

4. The tire of claim 3 wherein the bridged longitudinal groove comprises a plurality of bridged portions, each bridge possessing a longitudinal sipe.

5. The tire of claim 4 wherein the plurality of longitudinal ribs have a plurality of longitudinally spaced apart lateral sipes

6. The tire of claim 5 wherein the plurality of longitudinally spaced apart lateral sipes extend across the width of the plurality of longitudinal ribs.

7. The tire of claim 6 wherein the plurality of longitudinally spaced apart lateral sipes possess a pair of opposed surfaces within the sipe and the opposed surfaces make contact with each other when the tire is loaded.

8. The tire of claim 1, wherein the at least one of the plurality of continuous central ribs has at least one but less than five lateral grooves.

9. The tire of claim 1 wherein the tread substantially formed of an elastomeric material characterized as having a compression set greater than 5%.

10. The tire tread of claim 9 wherein the tread is substantially formed of an elastomeric material characterized as having an (MA10) of 5.75 to 9.5 MPa and MA300 of 1.3 to 1.7 MPa.

11. The tire tread of claim 10 wherein the tread is substantially formed of an elastomeric material characterized as having an (MA10) of 6.1 to 6.7 Pa and MA300 of 1.4 to 1.7 MPa.

12. The tire tread of claim 1, where each of the inner and outer shoulder ribs have a width equal to 19% to 35% of the tread width.

13. The tire tread of claim 1, where each of the inner and outer shoulder ribs have a width equal to 19 to 25% of the tread width.

14. The tire tread of claim 10 further comprising a center section, the center section forming a portion of the crown extending between the pair of shoulders, the center section and shoulders, the center section having a center contact surface ratio, and the pair of shoulders having a first contact surface ratio and a second contact surface ratio, wherein the center contact surface ratio is greater than the first shoulder contact surface ratio and the center contact surface ratio is greater than the second contact surface ratio.
